(19) United States
(12) Patent Application Publication
(10) Pub. No.: US 2026/0179058 A1
(43) Pub. Date: Jun. 25, 2026

(54) INTERACTIVE STICKERS

(71) Applicant: Lemon Inc., Grand Cayman (KY)

(72) Inventors: Mengyu ZHANG, Culver City, CA (US); Long JIANG, Culver City, CA (US)

(21) Appl. No.: 18/990,440

(22) Filed: Dec. 20, 2024

(51) Int. Cl. G06Q 10/40

(52) U.S. Cl. CPC G06Q 10/40

(57) ABSTRACT

Examples are disclosed that relate to promoting two-way interaction in a social media application using an interactive sticker. In one example, a social media application configured to generate a messaging graphical user interface (GUI) is executed by a sender-side computing device. An interactive sticker is displayed in the messaging GUI. A display message is sent to a receiver-side computing device. The receiver-side computing device displays the interactive sticker in a corresponding GUI based on receiving the display message. An interaction message is received from a receiver-side computing device based at least on the interactive sticker being interacted with at the receiver-side computing device. Hidden content associated with the interactive sticker is displayed in the messaging GUI based on receiving the interaction message. The receiver-side computing device displays the hidden content in the corresponding messaging GUI based on the interactive sticker being interacted with at the receiver-side computing device.

### BACKGROUND

Social media platforms have become integral to modern communication, providing users with dynamic ways to interact, share information, and form connections. Among the core features of these platforms, messaging applications play a pivotal role, enabling real-time or asynchronous communication between individuals or groups. These messaging systems are widely adopted in personal, professional, and public contexts, offering functionalities beyond traditional text exchanges, such as media sharing, voice, and video communication.

### SUMMARY

Examples are disclosed that relate to promoting two-way interaction in a social media application using an interactive sticker. In one example, a social media application configured to generate a messaging graphical user interface (GUI) is executed by a sender-side computing device. An interactive sticker is displayed in the messaging GUI. A display message is sent to a receiver-side computing device. The receiver-side computing device displays the interactive sticker in a corresponding GUI based on receiving the display message. An interaction message is received from a receiver-side computing device based at least on the interactive sticker being interacted with at the receiver-side computing device. Hidden content associated with the interactive sticker is displayed in the messaging GUI based on receiving the interaction message. The receiver-side computing device displays the hidden content in the corresponding messaging GUI based on the interactive sticker being interacted with at the receiver-side computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing environment in which two-way interaction between users of a social media application executed by different computing devices is promoted using an interactive sticker, according to one example of the present disclosure.

FIGS. 2 shows a messaging graphical user interface (GUI) including an interactive sticker button that is selectable to display an interactive stick to promote two-way interaction between a first user of a sender-side computing device and a second user of a receiver-side computing device of the computing environment of FIG. 1, according to one example of the present disclosure.

FIG. 3 shows an educational overlay that is displayed in the messaging GUI to educate a user how to use the interactive sticker button shown in FIG. 2, according to one example of the present disclosure.

FIG. 4 shows a scenario where the first user provides user input to the sender-side computing device to display an interactive sticker in the messaging GUI of the sender-side computing device and the receiver-side computing device, according to one example of the present disclosure.

FIG. 5 shows a visual appearance of the interactive sticker being adjusted based at least on a duration for which the interactive sticker has been displayed in the messaging GUI becoming greater than a threshold duration, according to one example of the present disclosure.

FIG. 6 shows the interactive sticker being removed from the messaging GUI based at least on a duration for which the interactive sticker has been displayed in the messaging GUI becoming greater than a threshold duration, according to one example of the present disclosure.

FIG. 7 shows a scenario where the second user provides user input to the receiver-side computing device to interact with the interactive sticker, according to one example of the present disclosure.

FIG. 8 shows a scenario where the hidden content associated with the interactive sticker is displayed in the messaging GUI of the sender-side computing device and the receiver-side computing device based at least on the second user interacting with the interactive sticker, according to one example of the present disclosure.

FIG. 9 shows a content collection GUI including a collection of previously revealed content of interactive sticker previously received by the second user of the receiver-side computing device, according to one example of the present disclosure.

FIG. 10 is a flowchart of an example method performed by a sender-side computing device to display an interactive sticker in a messaging GUI of a receiver-side computing device, according to one example of the present disclosure.

FIGS. 11-12 illustrate a flowchart of an example method performed by a receiver-side computing device for interacting with an interactive sticker, according to one example of the present disclosure.

FIG. 13 schematically shows an example computing system representative of the computing devices and computing system of FIG. 1.

### DETAILED DESCRIPTION

Lightweight interactions provided to users of a social media application can effectively increase direct message (DM) penetration and DM pairing between users of the social media application, especially for users that are typically inactive. For example, lightweight interactions can include greetings, nudging/reminders, suggestions to reach out to specific users, good morning messages and good night messages, among other types of lightweight interactions. These lightweight interactions prompt a user to engage with other users in the social media application. However, repeatedly sending lightweight interactions to a particular user may lead to a loss of interest in the social media application and/or result in the risk of the user starting low-quality conversations with other users that do not have lasting engagement.

Accordingly, examples are disclosed of a server system configured to implement a social media platform via which users can transmit interactive stickers having hidden content that is revealed based at least on two-way interaction from both a sender and a receiver of the sticker using a social media application. The interactive stickers promote longer lasting, quality interactions between the users. In particular, the hidden content provides an incentive for the users to engage with each other, and interactive stickers can be repeatedly sent between the users to increase the stickiness of the interaction between the users over time.

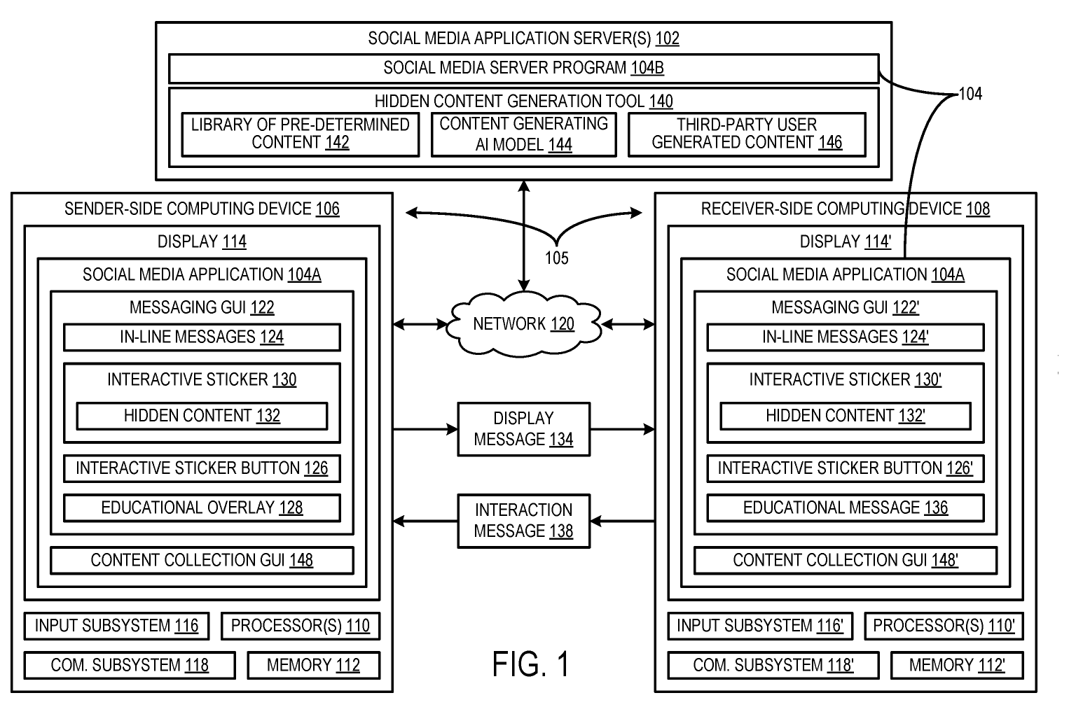

FIG. 1 shows a schematic view of an example computing environment 100 in which two-way interaction between users of a social media application is promoted using interactive stickers, according to one example of the present disclosure. The computing environment 100 includes one or a plurality of social media application servers 102 that are each configured to support operation of a social media application 104. The social media application 104 includes social media client application 104A executed on client computing devices 105 and social media server application 104B executed on social media application servers 102. The social media server application 104B is designed to facilitate communication, content sharing, networking, and other interactions among different users of social media client application 104B executed by different client computing devices. Social media application server 102 typically includes one or a plurality of servers configured to execute the social media server application 104B instances. The social media client application 104A can be executed by different users using different types of computing devices, such as mobile smartphones, desktop computers, tablet computers, etc., and may be a stand-alone executable application or a web browser accessing a website of the social media application 104, for example.

In one example, a first user associated with a sender-side computing device 106 can communicate with a second user associated with a receiver-side computing device 108 via the social media application 104 and servers of social media application server 102. The computing devices are referred to as “sender-side” and “receiver-side” for purposes of clarity in describing a scenario in which an interactive sticker is “sent” by the sender-side computing device 106 to the receiver-side computing device 108 as will be described in further detail herein. Although, it will be appreciated that both computing devices 106 and 108 are configured to send and receive interactive stickers and other messages.

The sender-side computing device 106 comprises one or more processors 110, memory 112, a display 114, an input subsystem 116, and a communication subsystem 118. The processor(s) 110 are configured to execute instructions stored in the memory 112 to perform computing operations that control operation of the sender-side computing device 106. The display 114 is configured to present a visual representation of data held in memory 112. The visual representation may take the form of one or more graphical user interfaces (GUIs). The input subsystem 116 is configured to translate user input (e.g., pressing keys, moving a mouse, touching a touch-sensitive display) into signals that affect control of the sender-side computing device 106. The communication subsystem 118 is configured to connect the sender-side computing device 106 to the receiver-side computing device 108 via a communication network 120, such as the Internet.

The receiver-side computing device 108 comprises one or more processors 110’, memory 112’, a display 114’, an input subsystem 116’, and a communication subsystem 118’. These components may function in the same manner as the corresponding components of the sender-side computing device 106 as described above.

The first user of the sender-side computing device 106 and the second user of the receiver-side computing device 108 communicate with each other via the social media application. In particular, the processor(s) 110 of the sender-side computing device 106 are configured to execute instructions stored in the memory 112 to execute the social media application 104. The social media application 104 is configured to generate a messaging graphical user interface (GUI) via the display 114. The messaging GUI 122 facilitates communication between the first user associated with the sender-side computing device 106 and the second user associated with the receiver-side computing device 108 by enabling the first user and the second user to send messages (and/or other content) back and forth to each other in the messaging GUI 122. In one example, the messaging GUI 122 includes a sequence of in-line messages 124 sent between the first user and the second user via the social media application 104.

The processor(s) 110’ of the receiver-side computing device 108 are configured to execute instructions stored in the memory 112’ to execute the social media application 104. The social media application 104 is configured to generate a corresponding messaging GUI 122’ via the display 114’ that enables the second user to view a corresponding sequence in-line messages 124’ and send additional messages (and/or other content) to the first user.

In some implementations, the appearance of the messaging GUI 122 and the corresponding messaging GUI 122’ may differ based at least on the perspective of the user. More particularly, the sequence of in-line messages 124 and the corresponding sequence of in-line messages 124’ may differ in appearance and/or order based at least on the perspective of the sender and receiver of the messages. As one example, the sequence of in-line messages 124 displayed in the messaging GUI 122 via the display 114 of the sender-side computing device 106 can be colored coded, such that messages sent by the first user are blue and messages received from the second user are green. The sequence of corresponding in-line messages 124’ displayed in the corresponding messaging GUI 122’ via the display 114’ of the receiver-side computing device 108 can be colored coded in the opposite manner, such that the messages sent by the second user are blue and the messages received from the first user are green.

The social media application 104 is configured to display, via the display 114, an interactive sticker button 126 in the messaging GUI 122. Likewise, the social media application 104 is configured to display, via the display 114’, a corresponding interactive sticker button 126’ in the corresponding messaging GUI 122’. The interactive sticker buttons 126/126’ are configured to be selectable via user input to trigger display of a corresponding interactive sticker in the messaging GUIs 122/122’.

In some implementations, the social media application 104 is configured to display, via the display 114, an educational overlay 128 that emphasizes the interactive sticker button 126 in the messaging GUI 122 to bring it to the attention of the first user. The educational overlay 128 includes instructions for using the interactive sticker button 126 to display the interactive sticker 130 in the messaging GUI 122. The educational overlay 128 can be displayed temporarily in order to educate the first user how to use the interactive sticker button 126. For example, the educational overlay 128 can be presented a first time the first user opens the messaging GUI 122 after the interactive sticker button 126 is displayed in the messaging GUI 122. In one example, the educational overlay 128 is removed from being displayed in the messaging GUI 122 based at least on the input subsystem 116 receiving user input corresponding to a selection in a location of the messaging GUI 122 that is outside the educational overlay 128. In other words, the educational overlay 128 disappears when the first user clicks or touches a different part of the messaging GUI 122 outside the educational overlay 128. In another example, the educational overlay 128 is removed from being displayed in the messaging GUI 122 based at least on a duration that the educational overlay 128 is displayed becoming greater than a threshold duration (e.g., 15 seconds).

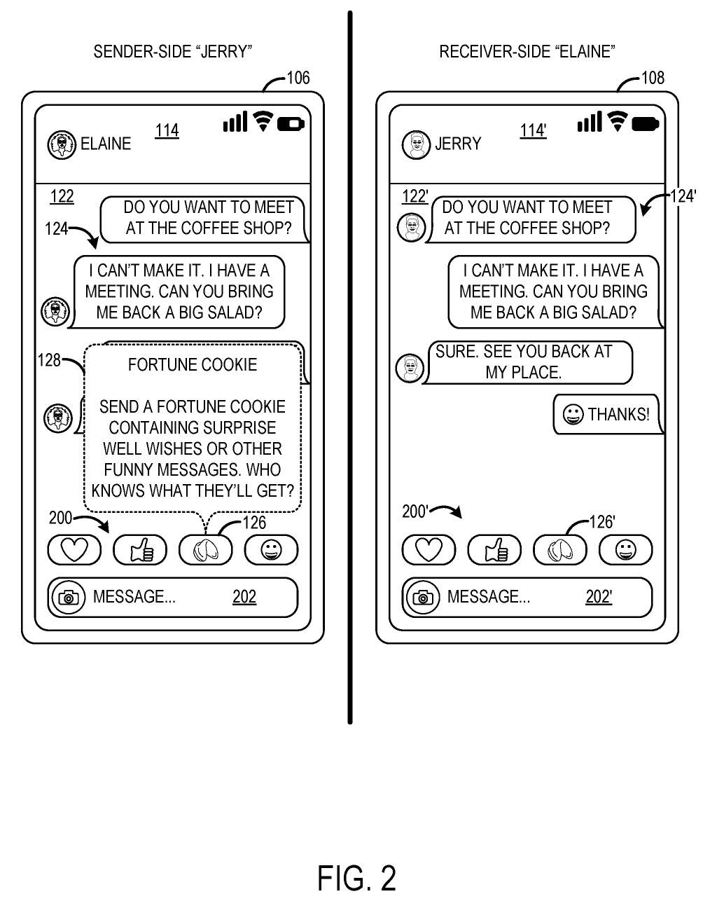

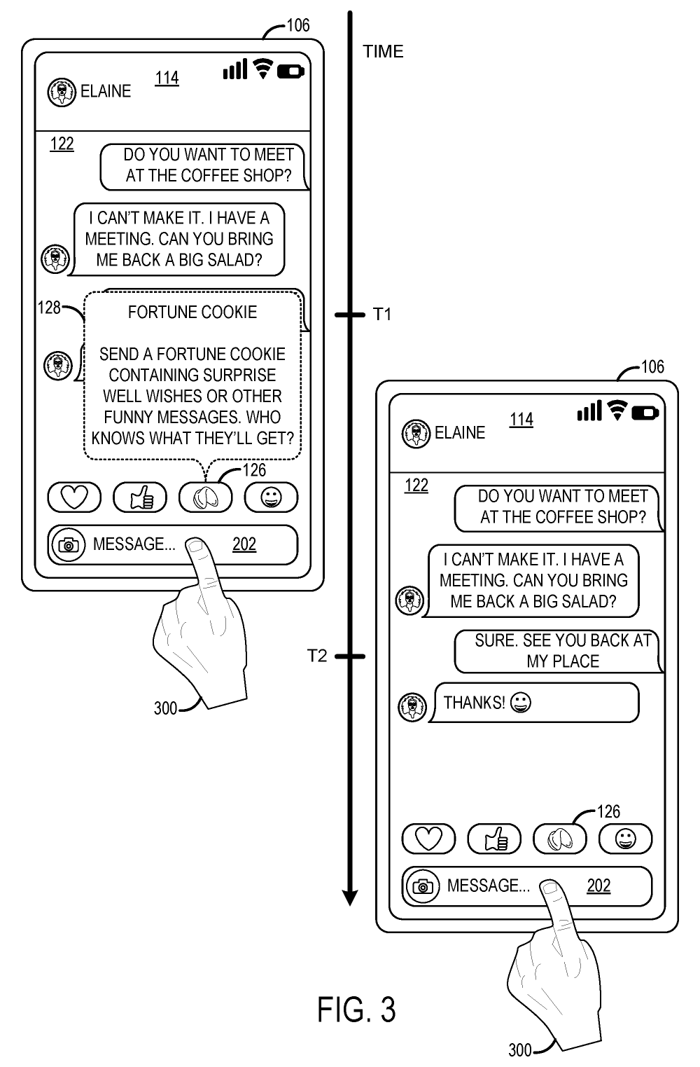

FIGS. 2-3 show an example scenario where the educational overlay 128 for using the interactive sticker button 126 is displayed in the messaging GUI 122. In FIG. 2, the first user, “Jerry” associated with the sender-side computing device 106, is having a conversation with the second user, “Elaine” associated with the receiver-side computing device 108.

The messaging GUI 122 is displayed via the display 114 of the sender-side computing device 106. The messaging GUI 122 includes the sequence of in-line messages 124 sent between Jerry and Elaine from the perspective of Jerry. The messaging GUI 122 includes a plurality of buttons 200 that are each selectable via user input (e.g., touch input to the display 114) to trigger display of a corresponding piece of content, such as an interactive sticker or an emoji. The messaging GUI 122 includes an input field 202 configured to enable Jerry to display a new message to Elaine or other content (e.g., image, gif, emoji) in the sequence of in-lines messages 124.

Further, the corresponding messaging GUI 122’ is displayed via the display 114’ of the receiver-side computing device 108. The corresponding messaging GUI 122’ includes the corresponding sequence of in-line messages 124’ sent between Jerry and Elaine from the perspective of Elaine. The messaging GUI 122’ includes a corresponding plurality of buttons 200’ that are each selectable via user input (e.g., touch input to the display 114’) to trigger display of a corresponding piece of content, such as an interactive sticker or an emoji. The corresponding messaging GUI 122’ includes an input field 202’ configured to enable Elaine to display a new message to Jerry or other content (e.g., image, gif, emoji) in the corresponding sequence of in-line messages 124’.

Note that the messaging GUI 122 and the corresponding messaging GUI 122’ show an interaction between Jerry and Elaine. The social media application 104 is configured to facilitate other interactions with other users and display other messaging GUIs that show those other interactions with the other users. For example, the social media application 104 can be configured to display another messaging GUI that shows an interaction between the first user and a third user. Further, the social media application 104 can be configured to display another messaging GUI that shows an interaction between the second user and a fourth user. In some examples, the social media application 104 can be configured to display messaging GUIs that show interactions between more than two users, such as a group chat. Correspondingly, in some implementations, the social media application 104 can be configured to enable a user to send an interactive sticker to a plurality of other user in a group chat, and hidden content associated with the interactive sticker may be revealed after all users in the group chat have interacted with the interactive sticker.

In the example illustrated in FIG. 2, the social media application 104 is configured to display, via the display 114, the interactive sticker button 126 in the form of a fortune cookie. As shown in the messaging GUI 122, the social media application 104 is configured to display, via the display 114, the educational overlay 128 to emphasize the interactive sticker button 126. The educational overlay 128 includes instructions for using the interactive sticker button 126 to display the interactive sticker 130 in the messaging GUI 122. In particular, the instructions state, “SEND A FORTUNE COOKIE CONTAINING SURPRISE WELL WISHES OR OTHER FUNNY MESSAGES. WHO KNOWS WHAT THEY’LL GET?” In this example, the instructions are tailored to the content of the interactive sticker, namely, the fortune cookie includes a fortune type message.

In FIG. 3, at time T1, the educational overlay 128 is displayed in the messaging GUI 122 of the sender-side computing device 106 in order to educate Jerry how to use the interactive sticker button 126. A hand 300 of Jerry provides touch input to the display 114 at a location in the messaging GUI 122 that is outside of the educational overlay 128. As shown at time T2, the touch input provided by the hand 300 causes the educational overlay 128 to be removed from being displayed in the messaging GUI 122. In other examples, the educational overlay 128 can be removed from being displayed in the messaging GUI 122 based at least on other conditions, such as a duration that the educational overlay 128 is displayed in the messaging GUI 122 becoming greater than a threshold duration.

In some implementations, the educational overlay 128 is displayed a single time upon the first user navigating to the messaging GUI 122 in the social media application 104 after the interactive sticker button 126 has been initially added to the messaging GUI 122 to alert the first user to the presence of the interactive sticker button 126. In other implementations, the educational overlay 128 is periodically displayed in the messaging GUI 122 to remind the user of the presence of the interactive sticker button 126. In some implementations, the frequency at which the educational overlay 128 is displayed can be based at least on a frequency of use of the interactive sticker button 126. For example, the less the first user uses the interactive sticker button 126 the more frequently the educational overlay 128 is displayed in the messaging GUI 122.

Returning to FIG. 1, the processor(s) 110 of the sender-side computing device 106 are configured to execute instructions stored in memory 112 to receive, via the input subsystem 116, user input indicating selection of the interactive sticker button 126 in the messaging GUI 122. The processor(s) 110 of the sender-side computing device 106 are configured to execute instructions stored in memory 112 to display, via the display 114, the interactive sticker 130 in the messaging GUI 122 based at least on the interactive sticker button being selected via the user input. The interactive sticker 130 is associated with hidden content 132 that is not initially displayed in the messaging GUI 122 when the interactive sticker 130 is displayed in the messaging GUI 122. Further, the processor(s) 110 of the sender-side computing device 106 are configured to execute instructions stored in memory 112 to send, via the communication network 120, an interactive sticker display message 134 to the receiver-side computing device 108 based at least on the interactive sticker 130 being displayed in the messaging GUI 122.

In some implementations, the interactive sticker display message 134 is routed through the social media application server 102, such that the social media application server 102 forwards the interactive sticker display message 134 to the receiver-side computing device 108.

The processor(s) 110’ of the receiver-side computing device 108 are configured to execute instructions stored in the memory 112’ to display a corresponding interactive sticker 130’ in the corresponding messaging GUI 122 via the display 114’ of the receiver-side computing device 108 based at least on receiving the interactive sticker display message 134.

The interaction of the first user to select the interactive sticker button 126 causes the interactive stickers 130/130’ to be displayed in the messaging GUIs 122/122’ of both the sender-side computing device 106 and the receiver-side computing device 108. Further, the hidden content 132/132’ associated with the interactive stickers 130/130’ remains hidden in order to encourage the second user to interact with the interactive sticker 130’. Such two-way interaction makes the fist and second users more likely to interact with the social media application 104, and more particularly, to use the social media application 104 to interact with each other.

In some implementations, the processor(s) 110’ are configured to execute instructions stored in the memory 112’ to display an educational message 136 that emphasizes the interactive sticker 130’ in the messaging GUI 122’. The educational message 136 includes instructions for interacting with the interactive sticker 130’ to display the hidden content 132’ in the messaging GUI 122’ of the receiver-side computing device 108.

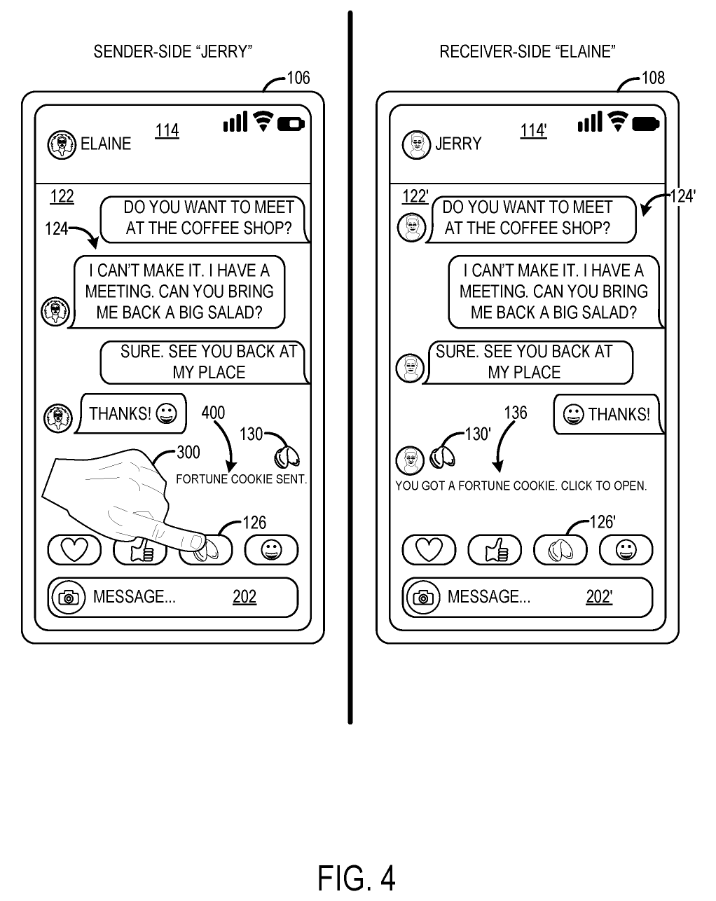

Returning to the example of the fortune cookie interactive sticker, in FIG. 4, the first user, Jerry, provides touch input via the hand 300 to select the interactive sticker button 126 for the fortune cookie interactive sticker. Based at least on interactive sticker button 126 being selected via the user input, the sender-side computing device 106 is configured to display the interactive sticker 130 in the sequence of in-line messages 124 in the messaging GUI 122. The hidden content 132 associated with the interactive sticker 130 remains hidden when the interactive sticker 130 is initially displayed in the messaging GUI 122.

Further, the sender-side computing device 106 sends the interactive sticker display message 134 (shown in FIG. 1) to the receiver-side computing device 108 based at least on the interactive sticker 130 being displayed in the messaging GUI 122 in order to notify the receiver-side computing device 108. The receiver-side computing device 108 displays a corresponding interactive sticker 130’ in the corresponding sequence of in-line messages 124 of the messaging GUI 122’ based at least on receiving the interactive sticker display message 134 (shown in FIG. 1). The hidden content 132’ associated with the interactive sticker 130’ remains hidden when the interactive sticker 130’ is initially displayed in the messaging GUI 122’.

In the illustrated example, the interactive stickers 130/130’ are icons depicting a fortune cookie. In other examples, interactive stickers 130/130’ can depict other types of content.

In some implementations, the sender-side computing device 106 is configured to display a confirmation message 400 based at least on sending the interactive sticker display message 134 (shown in FIG. 1) to the receiver-side computing device 108. The confirmation message 400 notifies the Jerry that the fortune cookie has been sent to Elaine. In some examples, the confirmation message 400 is displayed in the messaging GUI 122 until Elaine interacts with the fortune cookie 130’ in the messaging GUI 122’ of the receiver-side computing device 108, at which point the confirmation message 400 is removed from being displayed in the messaging GUI 122. In other examples, the confirmation message 400 is removed from being displayed in the messaging GUI 122 after a duration for which the confirmation message 400 is displayed becomes greater than a threshold duration. In yet other examples, the confirmation message 400 is removed from being displayed in the messaging GUI 122 based at least on user input being received (e.g., either clicking on the message or clicking at another location in the messaging GUI).

In some implementations, the processor(s) 110’ of the receiver-side computing device 108 are configured to execute instructions stored in the memory 112’ to display an educational message 136 that emphasizes the interactive sticker 130’ in the messaging GUI 122’. The educational message 136 includes instructions for interacting with the interactive sticker 130’ to display the hidden content 132’ associated with the interactive sticker 130’ in the messaging GUI 122’. In the illustrated example, the educational message 136 states, “YOU GOT A FORTUNE COOKIE. CLICK TO OPEN.”

In some examples, the educational message 136 is displayed in the messaging GUI 122’ until Elaine interacts with the fortune cookie 130’ via user input, at which point the educational message 136 is removed from being displayed in the messaging GUI 122’. In other examples, the educational message 136 is removed from being displayed in the messaging GUI 122’ after a duration for which the educational message 136 is displayed becomes greater than a threshold duration.

In some implementations, the social media application 104 is configured to perform various actions to reduce the likelihood of the interactive sticker 130’ from being ignored by the second user in the messaging GUI 122’.

In some implementations, the processor(s) 110’ of the receiver-side computing device 108 are configured to execute instructions stored in the memory 112’ to adjust, via the display 114, a visual appearance of the interactive sticker 130’ in the messaging GUI 122’ based at least on a duration for which the interactive sticker 130’ has been displayed in the messaging GUI 122’ becoming greater than a threshold duration.

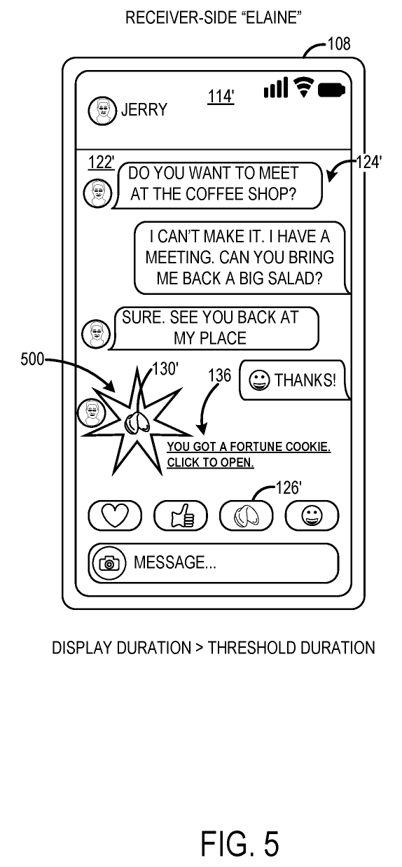

Returning to the example of the fortune cookie interactive sticker, in FIG. 5, based at least on the duration for which the interactive sticker 130’ has been displayed in the messaging GUI 122’ becoming greater than a threshold duration, the visual appearance of the fortune cookie 130’ is adjusted to place greater visual emphasis on the fortune cookie 130’ in the messaging GUI 122’. In particular, the fortune cookie 130’ is augmented with a bold explosion bubble 500. Additionally, visual appearance of the educational message 136 is adjusted to have font that is bold and underlined. The altered visual appearance of the fortune cookie 130’ and the educational message 136 draws the attention of Elaine over the other messages in the sequence of in-line messages 124 and encourages Elaine to interact with the fortune cookie 130’. In other examples, the visual appearance of the fortune cookie 130’ can be altered in a different manner. For example, the fortune cookie 130’ can be animated to shake back and forth to draw the attention of Elaine to interact with the fortune cookie 130’. In still other examples, the color of the fortune cookie 130’ can be changed to draw the attention of Elaine to the fortune cookie 130’ over the other messages in the sequence of in-line messages 124’.

In some implementations, the processor(s) 110’ of the receiver-side computing device 108 are configured to execute instructions stored in the memory 112’ to remove the interactive sticker 130’ from being displayed in the messaging GUI 122’ based at least on a duration for which the interactive sticker 130’ has been displayed in the messaging GUI 122’ becoming greater than a threshold duration. By removing the interactive sticker 130’ from being displayed in the messaging GUI 122’ in this manner, the interactive sticker 130’ is prevented from becoming stale and clogging up the sequence of in-line messages 124’ in the messaging GUI 122’ with unwanted content as deemed by the second user not interacting with the interactive sticker 130’ for the threshold duration.

In some implementations, based at least on the interactive sticker 130’ being removed from being displayed in the messaging GUI 122’, the receiver-side computing device 108 is configured to send a notification message to the sender-side computing device 106. The sender-side computing device 106 can be configured to remove the interactive sticker 130 from the messaging GUI 122 of the sender-side computing device 106 based at least on receiving the notification message from the receiver-side computing device 108. Additionally, or alternatively, the sender-side computing device 106 can be configured to display a notification in the messaging GUI 122 that notifies the first user that the second user did not interact with the interactive sticker 130’. At which point, the first user can attempt to resend the interactive sticker 130’ to the second user.

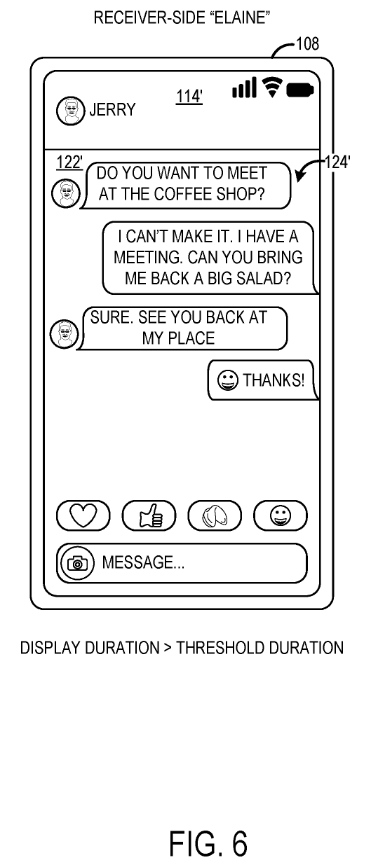

Returning to the example of the fortune cookie interactive sticker, in FIG. 6, based at least on the duration for which the interactive sticker 130’ has been displayed in the messaging GUI 122’ becoming greater than a threshold duration, the fortune cookie 130’ is removed from being displayed in the messaging GUI 122’ and the sequence of in-line messages 124’ reverts to its previous state, before the fortune cookie 130’ was displayed in the messaging GUI 122’.

Returning to FIG. 1, the processor(s) 110’ of the receiver-side computing device 108 are configured to execute instructions stored in the memory 112’ to receive, via the input subsystem 116’, user input that interacts with the interactive sticker 130’ in the messaging GUI 122’. The processor(s) 110’ of the receiver-side computing device 108 are configured to execute instructions stored in the memory 112’ to send, via the communication network 120, an interactive sticker interaction message 138 to the sender-side computing device 106 based at least on receiving the user input that interacts with the interactive sticker 130’ in the messaging GUI 122’.

In some implementations, the interactive sticker interaction message 138 is routed through the social media application server 102, such that the social media application server 102 forwards the interactive sticker interaction message 138 to the sender-side computing device 106.

Further, the processor(s) 110’ of the receiver-side computing device 108 are configured to execute instructions stored in the memory 112’ to display, via the display 114’, the hidden content 132’ associated with the interactive sticker 130’ in the messaging GUI 122’ based at least on receiving the user input that interacts with the interactive sticker 130’ in the messaging GUI 122’. In some examples, the hidden content 132’ is displayed in the sequence of in-line messages 124’. In other examples, the hidden content 132’ can be displayed in other regions of the messaging GUI 122’.

The processor(s) 110 of the sender-side computing device 106 are configured to execute instructions stored in the memory 112 to display, via the display 114, the hidden content 132 associated with the interactive sticker 130 in the messaging GUI 122 based at least on receiving the interactive sticker interaction message 138 from the receiver-side computing device 108. In some examples, the hidden content 132 is displayed in the sequence of in-line messages 124. In other examples, the hidden content 132 can be displayed in other regions of the messaging GUI 122.

In some implementations, the hidden content 132/132’ replaces the interactive sticker 130/130’ in the messaging GUI 122/122’ when the hidden content 132/132’ is displayed in the messaging GUI 122/122’. In other implementations, the interactive sticker 130/130’ remains displayed in the messaging GUI 122/122’ when the hidden content 132/132’ is revealed in the messaging GUI 122/122’.

The hidden content 132/ 132’ may include any suitable content including text, audio, video, animation, or a combination thereof.

The social media application server 102 is configured to execute a hidden content generation tool 140 that is configured to generate the hidden content 132/132’ associated with the interactive sticker 130/130’. The hidden content generation tool 140 is configured to generate hidden content 132/132’ associated with any suitable interactive stickers. The hidden content generation tool 140 can be configured to generate hidden content 132/132’ from various sources in different implementations.

In some implementations, the hidden content generation tool 140 is configured to generate the hidden content 132/132’ by selecting a piece of pre-determined content from a library of pre-determined content 142 that is curated by the hidden content generation tool 140. In the example of the fortune cookie interactive sticker, the library of pre-determined content 142 includes a plurality of different fortunes, and the hidden content generation tool 140 selects a particular fortune from the plurality of different fortunes. In some examples, the hidden content generation tool 140 selects a particular fortune from the plurality of fortunes at random to associate with the interactive sticker 130/130’. In other examples, the hidden content generation tool 140 selects a particular fortune from the plurality of fortunes based at least on other factors, such as personal information (e.g., birth date) or personal preferences of the second user.

In some implementations, the hidden content generation tool 140 is configured to generate the hidden content 132/132’ using a content generating artificial intelligence (AI) model 144. The content generating AI model 144 is configured to receive an input prompt and output the hidden content 132/132’ based at least on the input prompt. In some examples, the input prompt is a user prompt provided by a user that wants to send a fortune cookie to another user. In some examples, the input prompt is a text prompt. In other examples, the input prompt is other content, such as an image, an audio stream, or a video stream.

The content generating AI model 144 can be trained to output the hidden content 132/132’ based at least on the input prompt using suitable training data. Referring back to the example of the fortune cookie interactive sticker, the content generating AI model 144 can be trained to output fortunes for fortune cookies by focusing on creating concise, positive, and universally appealing statements. In one example, a dataset of existing fortune cookie messages can be collected and used as training data. For example, the training data can be collected from publicly available collections of fortunes, books or websites with quotes and proverbs, and/or user-generated content with optimistic or motivational themes, among other sources. In some examples, the content generating AI model 144 is a pre-trained natural language processing (NLP) model, or another type of transformer-based model. The content generating AI model 144 can be fine-tuned to focus on the specific tone and length required for the fortunes. In some examples, the content generating AI model 144 includes a post-processing layer or prompts to enforce constraints, such as limiting a word count, or filtering out inappropriate, overly negative, or complex outputs. In other examples, the content generating AI model 144 can be trained using a different approach.

In some implementations, the hidden content generation tool 140 is configured to generate the hidden content 132/132’ using third-party user generated content 146 that is generated by a third user that is linked to the first user and the second user in the social media application 104. For example, the third user can be a mutual friend to both the first user and the second user. The third user can have intimate knowledge of the first and second users, and can provide personalized content based at least on that knowledge.

In some implementations, the hidden content generation tool 140 can be configured to generate the hidden content 132/132’ using a combination of any of the approaches discussed above.

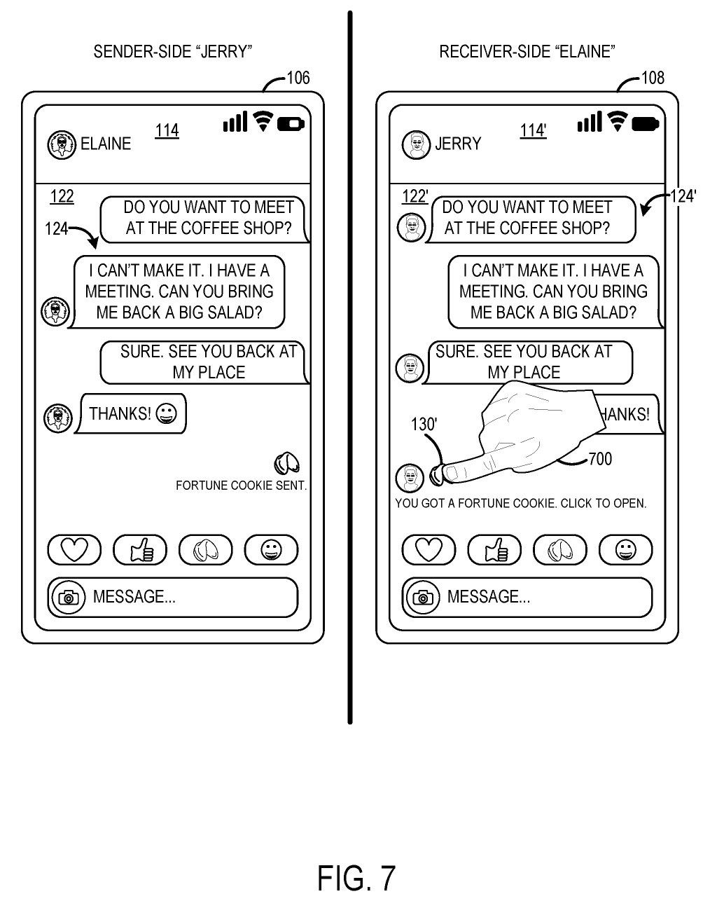

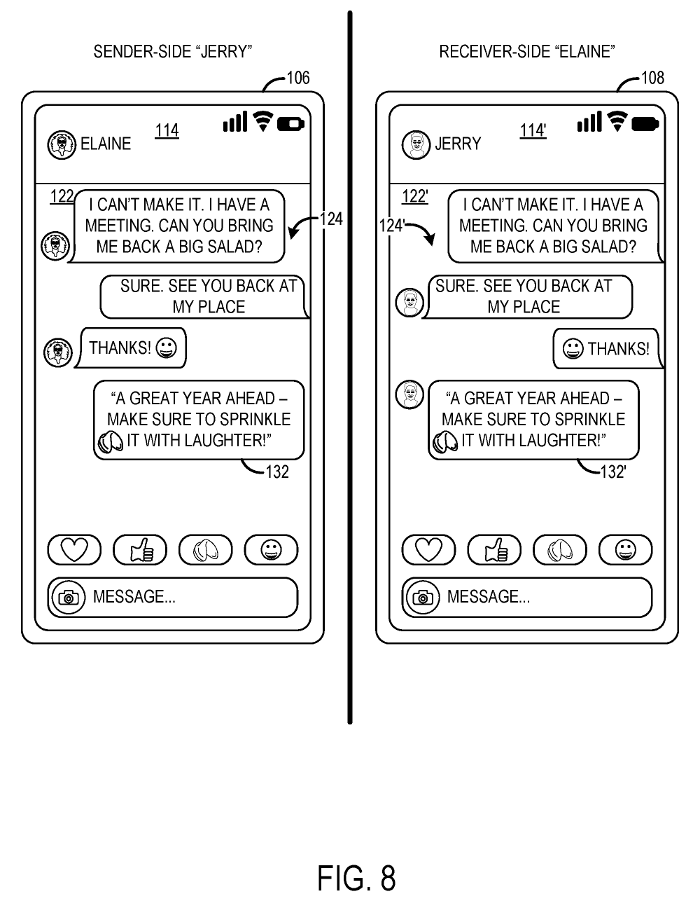

Returning to the example of the fortune cookie interactive sticker, FIGS. 7 and 8 show a scenario where Elaine interacts with the fortune cookie to reveal hidden content. In particular, as shown in FIG. 7, a hand 700 provides touch input to the display 114’ of the receiver-side computing device 108 to select or “click” on the fortune cookie 130’. Such interaction causes the receiver-side computing device 108 to send the interactive sticker interaction message 138 (shown in FIG. 1) to the sender-side computing device 106 to inform the sender-side computing device 106 of the interaction of the second user with the fortune cookie 130’.

In FIG. 8, the receiver-side computing device 108 is configured to display the hidden content in the form of a fortune 132’ in the messaging GUI 122’ based at least on the interaction with the fortune cookie 130’ provided by the user input of the hand 700 of Elaine (shown in FIG. 7). More particularly, the fortune 132’ is displayed in the sequence of in-line messages 124’ in the messaging GUI 122’. In this example, the fortune 132’ replaces the fortune cookie 130’ in the messaging GUI 122’ once Elaine clicks on the fortune cookie 130’ (as shown in FIG. 7). In the illustrated example, the fortune 132’ states, “A GREAT YEAR AHEAD- MAKE SURE TO SPRINKLE IT WITH LAUGHTER!” In other examples, the fortune 132’ may include other text, audio, video, and/or animations.

Likewise, the sender-side computing device 106 is configured to display the fortune 132 in the messaging GUI 122’ based at least on receiving the interactive sticker interaction message 138 (shown in FIG. 1) from the receiver-side computing device 108. More particularly, the fortune 132 is displayed in the sequence of in-line messages 124 in the messaging GUI 122. In this example, the fortune 132 replaces the fortune cookie 130 in the messaging GUI 122 once the interactive sticker interaction message 138 is received by the sender-side computing device 106. In the illustrated example, the fortune 132 states, “A GREAT YEAR AHEAD- MAKE SURE TO SPRINKLE IT WITH LAUGHTER!” In other examples, the fortune 132 may include other text, audio, video, and/or animations.

In the illustrated example, the interaction of Elaine with the fortune cookie 130’ in the messaging GUI 122’ closes a two-way interaction loop that involves interactions from both Jerry (by sending the fortune cookie) and Elaine (by clicking on the fortune cookie). Accordingly, Jerry and Elaine are rewarded for the two-way interaction by being given the privilege to view the fortune 132/132’ in the messaging GUI 122/122’. In other words, the two-way interaction acts as a mechanism for triggering the display of the fortune 132/132’ at both the sender-side computing device 106 and the receiver-side computing device 108. Revealing the fortune 132/132’ based at least on the two-way interaction encourages Jerry and Elaine to interact with the social media application 104, and more particularly, use the social media application 104 to interact with each other. Moreover, such interactions can be potentially longer lasting and more in-depth due to the two-way involvement of Jerry and Elaine to interact with the fortune cookie 130/130’. The conversation between the two can be further enhanced by sending additional interactive stickers that prompt additional interaction and engagement between the two users of the social media application 104.

Returning to FIG. 1, in some implementations, the social media application 104 is configured to generate a content collection GUI 148/148’ including a collection of previously reveled content associated with a plurality of interactive stickers. More particularly, the sender-side computing device 106 is configured to generate the content collection GUI 148 including a collection of previously reveled content associated with a plurality of interactive stickers received and interacted with by the first user. Further, the receiver-side computing device 108 is configured to generate the content collection GUI 148’ including a collection of previously reveled content associated with a plurality of interactive stickers received and interacted with by the second user. In other words, each computing device displays a collection of content that is personalized for each of the users.

The processor(s) 110 of the sender-side computing device 106 are configured to execute instructions stored in the memory 112 to receive, via the input subsystem 116, user input from the first user indicating user selection of the content collection GUI 148, and display the content collection GUI 148 including the collection of previously revealed content based at least on receiving the user input indicating user selection of the content collection GUI 148.

Further, the processor(s) 110’ of the receiver-side computing device 108 are configured to execute instructions stored in the memory 112’ to receive, via the input subsystem 116’, user input from the second user indicating user selection of the content collection GUI 14’8, and display the content collection GUI 148’ including the collection of previously revealed content based at least on receiving the user input indicating user selection of the content collection GUI 148’.

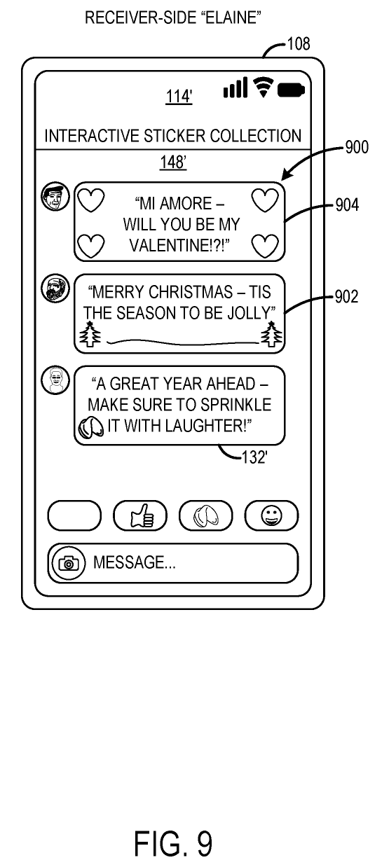

Returning to the example of the fortune cookie interactive sticker, in FIG. 9, the receiver-side computing device 108 is configured to display the content collection GUI 148’ via the display 114’. The content collection GUI 148’ includes a collection of previously revealed content 900 associated with interactive stickers that were sent to Elaine by different users of the social media application 104 and that were interacted with by Elaine to reveal the content. More particularly, the collection of previously revealed content 900 includes the fortune 132’ associated with the fortune cookie 130’ (shown in FIG. 7) that Jerry sent to Elaine. The collection of previously revealed content 900 further includes other previously revealed content associated with other interactive stickers sent to Elaine. As one example, the previously revealed content includes a Christmas message 902 associated with a Christmas card that was sent to Elaine. The Christmas message 902 message was revealed based at least on two-way interaction performed by both Elaine and the other user with the Christmas card. As another example, the previously revealed content includes a Valentine’s Day message 904 associated with a Valentine’s Day card that was sent to Elaine. The Valentine’s Day message 904 message was revealed based at least on two-way interaction performed by both Elaine and the other user with the Valentine’s Day card.

In some implementations, the social media application 104 is configured to enable a user to share their content collection with other users of the social media application 104 to allow the other users to view that user’s content collection.

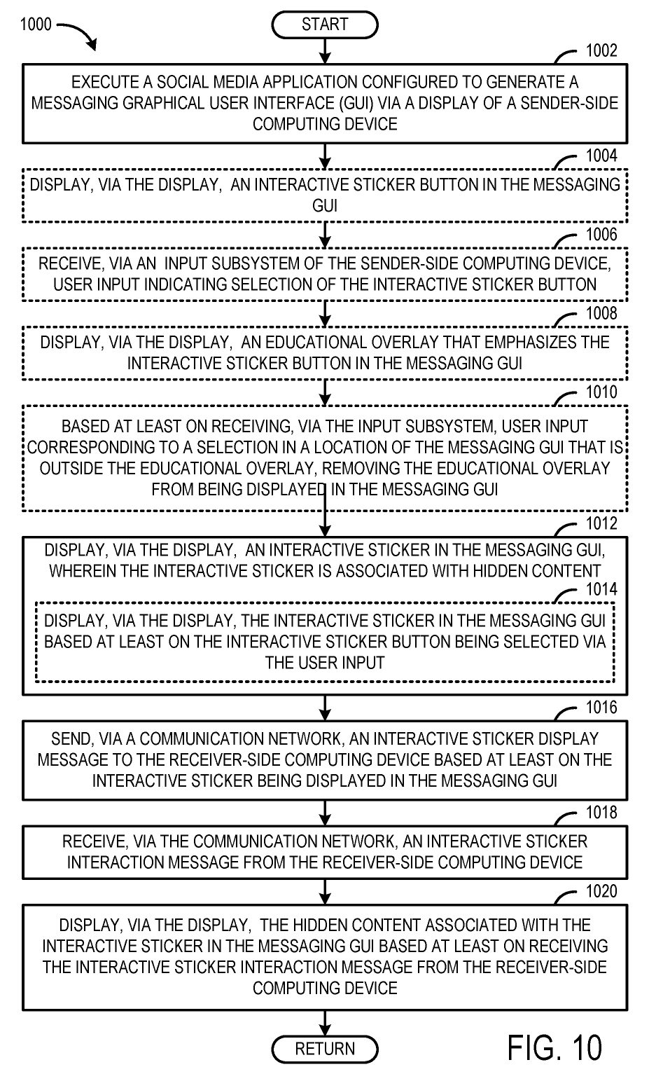

FIG. 10 shows example method 1000 performed by a sender-side computing device to display an interactive sticker in a messaging GUI of a receiver-side computing device, according to one example of the present disclosure. For example, the method 1000 can be performed by the sender-side computing device 106 shown in FIG. 1 or another type of computing device. Note that method steps shown in dotted lines can be optionally performed in some implementations.

At 1002, the method 1000 includes executing a social media application configured to generate a messaging GUI via a display of the sender-side computing device. The messaging GUI facilitates communication between a first user associated with the sender-side computing device and a second user associated with a receiver-side computing device.

In some implementations, at 1004, the method 1000 may include displaying an interactive sticker button in the messaging GUI.

In some implementations, at 1004, the method 1000 may include receiving, via an input subsystem of the sender-side computing device, user input indicating selection of the interactive sticker button.

In some implementations, at 1006, the method 1000 may include displaying an educational overlay that emphasizes the interactive sticker button in the messaging GUI. The educational overlay includes instructions for using the interactive sticker button to display the interactive sticker.

In some implementations, at 1010, the method 1000 may include, based at least on receiving, via the input subsystem, user input corresponding to a selection in a location of the messaging GUI that is outside the educational overlay, removing the educational overlay from being displayed in the messaging GUI.

At 1012, the method 1000 includes displaying an interactive sticker in the messaging GUI, wherein the interactive sticker is associated with hidden content.

In some implementations, at 1014, the method 1000 may include displaying the interactive sticker in the messaging GUI based at least on the interactive sticker button being selected via the user input.

At 1016, the method 1000 includes sending, via a communication network, an interactive sticker display message to the receiver-side computing device based at least on the interactive sticker being displayed in the messaging GUI. The receiver-side computing device is configured to display the interactive sticker in a corresponding messaging GUI displayed via a receiver-side display of the receiver-side computing device based at least on receiving the interactive sticker display message.

At 1018, the method 1000 includes receiving, via the communication network, an interactive sticker interaction message from the receiver-side computing device. The receiver-side computing device is configured to send the interactive sticker interaction message to the sender-side computing device based at least on the interactive sticker that is displayed in the corresponding messaging GUI being interacted with via user input to the receiver-side computing device.

At 1020, the method 1000 includes displaying the hidden content associated with the interactive sticker in the messaging GUI based at least on receiving the interactive sticker interaction message from the receiver-side computing device. The receiver-side computing device is configured to display the hidden content associated with the interactive sticker in the corresponding messaging GUI based at least on the interactive sticker being interacted with via the user input to the receiver-side computing device.

In some implementations, the hidden content may replace the interactive sticker in the messaging GUI when the hidden content is displayed in the messaging GUI. In some implementations, the messaging GUI may include a sequence of in-line messages sent between the first user and the second user, and the interactive sticker and/or the hidden content may be displayed in the sequence of in-line messages in the messaging GUI. In some implementations, the hidden content may comprise a piece of pre-determined content selected from a library of pre-determined content. In some implementations, the hidden content may comprise artificial intelligence (AI)-generated content that is generated based at least on a user prompt. In some implementations, the hidden content may comprise third-party content generated by a third user that is linked to the first user and the second user in the social media application.

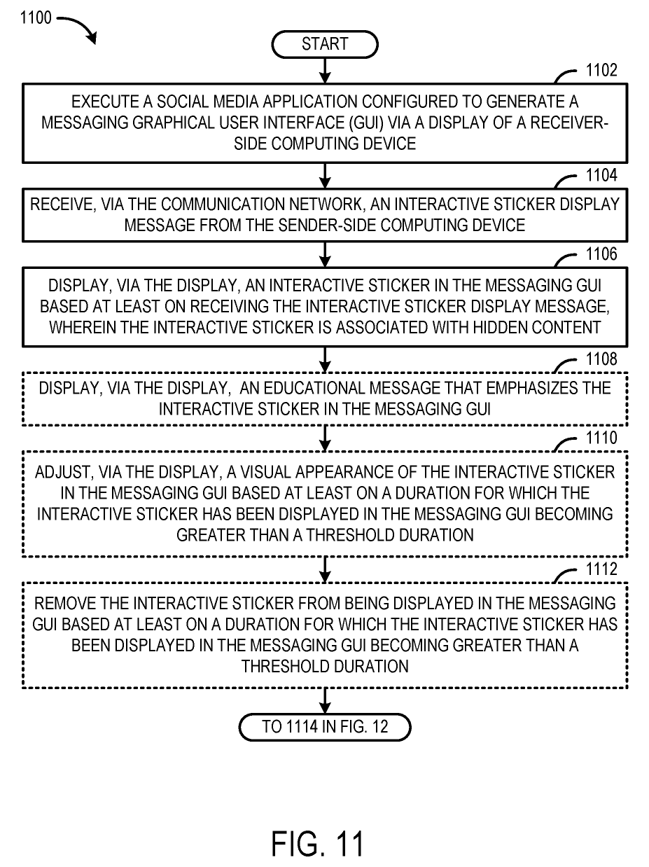

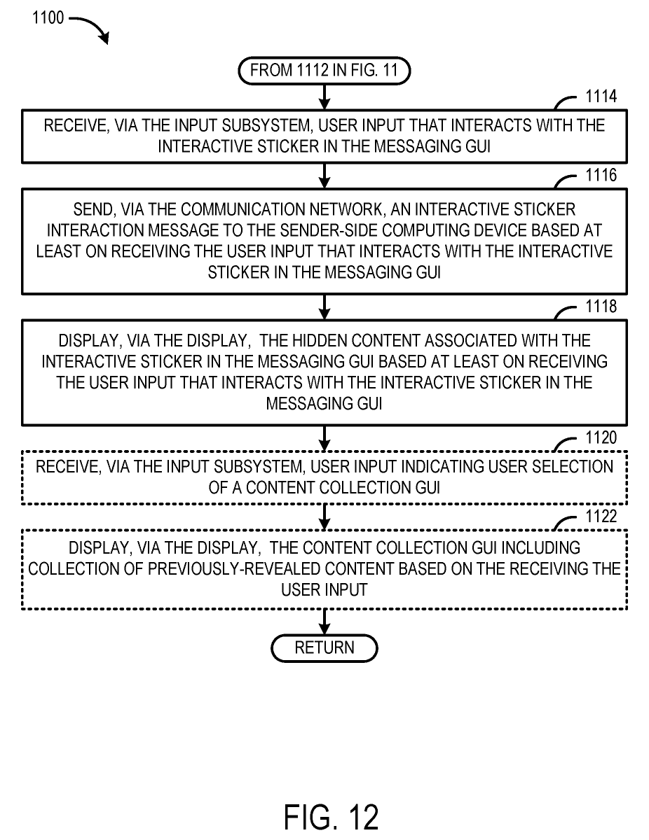

FIGS. 11-12 show an example method 1100 performed by a receiver-side computing device for interacting with an interactive sticker, according to one example of the present disclosure. For example, the method 1100 can be performed by the receiver-side computing device 108 shown in FIG. 1 or another type of computing device. Note that method steps shown in dotted lines can be optionally performed in some implementations.

In FIG. 11, at 1102, the method 1100 includes executing a social media application configured to generate a messaging GUI via a display of the receiver-side computing device. The messaging GUI facilitates communication between a first user associated with a sender-side computing device and a second user associated with the receiver-side computing device.

At 1104, the method 1100 includes receiving, via a communication network, an interactive sticker display message from the sender-side computing device.

At 1106, the method 1100 includes displaying an interactive sticker in the messaging GUI based at least on receiving the interactive sticker display message, wherein the interactive sticker is associated with hidden content.

In some implementations, at 1108, the method 1100 may include displaying an educational message that emphasizes the interactive sticker in the messaging GUI. The educational message includes instructions for interacting with the interactive sticker to display the hidden content in the messaging GUI.

In some implementations, at 1110, the method 1100 may include adjusting a visual appearance of the interactive sticker in the messaging GUI based at least on a duration for which the interactive sticker has been displayed in the messaging GUI becoming greater than a threshold duration.

In some implementations, at 1112, the method 1100 may include removing the interactive sticker from being displayed in the messaging GUI based at least on a duration for which the interactive sticker has been displayed in the messaging GUI becoming greater than a threshold duration.

In FIG. 12, at 1114, the method 1100 includes receiving, via the input subsystem, user input that interacts with the interactive sticker in the messaging GUI.

At 1116, the method 1100 includes sending, via the communication network, an interactive sticker interaction message to the sender-side computing device based at least on receiving the user input that interacts with the interactive sticker in the messaging GUI. The sender-side computing device is configured to display the hidden content associated with the interactive sticker in the corresponding messaging GUI based at least on receiving the interactive sticker interaction message.

At 1118, the method 1100 includes display the hidden content associated with the interactive sticker in the messaging GUI based at least on receiving the user input that interacts with the interactive sticker in the messaging GUI, wherein the sender-side computing device is configured to display the hidden content associated with the interactive sticker in the corresponding messaging GUI based at least on receiving the interactive sticker interaction message.

In some implementations, the hidden content may replace the interactive sticker in the messaging GUI when the hidden content is displayed in the messaging GUI. In some implementations, the messaging GUI may include a sequence of in-line messages sent between the first user and the second user, and the interactive sticker and/or the hidden content may be displayed in the sequence of in-line messages in the messaging GUI. In some implementations, the hidden content may comprise a piece of pre-determined content selected from a library of pre-determined content. In some implementations, the hidden content comprises artificial intelligence (AI)-generated content that is generated based at least on a user prompt. In some implementations, the hidden content comprises third-party content generated by a third user that is linked to the first user and the second user in the social media application.

In some implementations in which the social media application is configured to generate a content collection GUI including a collection of previously reveled content associated with a plurality of interactive stickers that the second user previously received and interacted with, at 1120, the method 1100 may include receiving, via the input subsystem, user input indicating user selection of the content collection GUI. In some implementations, at 1122, the method 1100 may include displaying, via the display, the content collection GUI including the collection of previously revealed content based at least on receiving the user input indicating user selection of the content collection GUI.

The methods 1000 and 1100 can be performed to promote two-way interaction between users of a social media application. More particularly, the interactive sticker and associated hidden content provide a mechanism that rewards both a first user and a user for interacting with the interactive sticker by being given the privilege to view the hidden content. Revealing the hidden content to both users based at least on the two-way interaction encourages both users to interact with the social media application, and more particularly, use the social media application to interact with each other. Moreover, such interactions can be potentially longer lasting and more in-depth due to the two-way involvement of both users to interact with the interactive sticker. The interactions between the two users can be further enhanced by sending additional interactive stickers that prompt additional interactions and engagement between the two users of the social media application.

In some embodiments, the methods and processes described herein may be tied to a computing system of one or more computing devices. In particular, such methods and processes may be implemented as a computer-application program or service, an application-programming interface (API), a library, and/or other computer-program product.

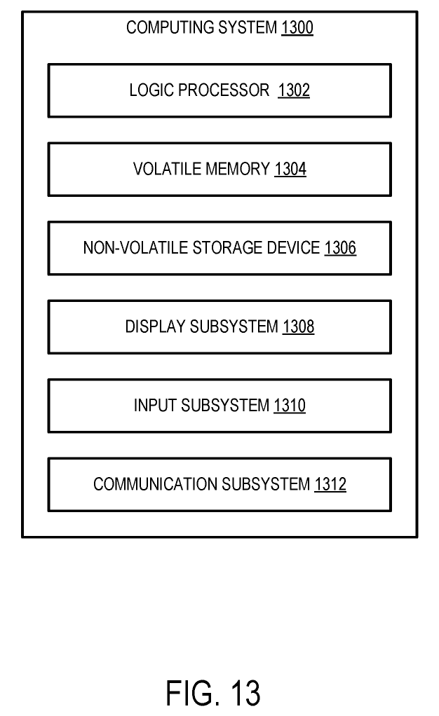

FIG. 13 schematically shows a non-limiting embodiment of a computing system 1300 that can enact one or more of the methods and processes described above. Computing system 1300 is shown in simplified form. Computing system 1300 may embody the social media application server 102, the sender-side computing device 106, and the receiver-side computing device 108 described above and illustrated in FIG. 1. Computing system 1300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1300 includes a logic processor 1302 volatile memory 1304, and a non-volatile storage device 1306. Computing system 1300 may optionally include a display subsystem 1308, input subsystem 1310, communication subsystem 1312, and/or other components not shown in FIG. 13.

Logic processor 1302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1306 includes one or more physical devices configured to hold instructions executable by the logic processors to implement the methods and processes described herein. When such methods and processes are implemented, the state of non-volatile storage device 1306 may be transformed—e.g., to hold different data.

Non-volatile storage device 1306 may include physical devices that are removable and/or built-in. Non-volatile storage device 1306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1306 may include nonvolatile, dynamic, static, read/write, read-only, sequential-access, location-addressable, file-addressable, and/or content-addressable devices. It will be appreciated that non-volatile storage device 1306 is configured to hold instructions even when power is cut to the non-volatile storage device 1306.

Volatile memory 1304 may include physical devices that include random access memory. Volatile memory 1304 is typically utilized by logic processor 1302 to temporarily store information during processing of software instructions. It will be appreciated that volatile memory 1304 typically does not continue to store instructions when power is cut to the volatile memory 1304.

Aspects of logic processor 1302, volatile memory 1304, and non-volatile storage device 1306 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 1300 typically implemented in software by a processor to perform a particular function using portions of volatile memory, which function involves transformative processing that specially configures the processor to perform the function. Thus, a module, program, or engine may be instantiated via logic processor 1302 executing instructions held by non-volatile storage device 1306, using portions of volatile memory 1304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1308 may be used to present a visual representation of data held by non-volatile storage device 1306. The visual representation may take the form of a graphical user interface (GUI). As the herein described methods and processes change the data held by the non-volatile storage device, and thus transform the state of the non-volatile storage device, the state of display subsystem 1308 may likewise be transformed to visually represent changes in the underlying data. Display subsystem 1308 may include one or more display devices utilizing virtually any type of technology. Such display devices may be combined with logic processor 1302, volatile memory 1304, and/or non-volatile storage device 1306 in a shared enclosure, or such display devices may be peripheral display devices.

When included, input subsystem 1310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; and/or other suitable sensor.

When included, communication subsystem 1312 may be configured to communicatively couple various computing devices described herein with each other, and with other devices. Communication subsystem 1312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 1300 to send and/or receive messages to and/or from other devices via a network such as the Internet.

The following paragraphs provide additional description of the subject matter of the present disclosure.

In an example, a sender-side computing device for social media application interaction comprises one or more processors configured to execute instructions stored in memory to execute a social media application configured to generate a messaging graphical user interface (GUI) via a display, wherein the messaging GUI facilitates communication between a first user associated with the sender-side computing device and a second user associated with a receiver-side computing device, display, via the display, an interactive sticker in the messaging GUI, wherein the interactive sticker is associated with hidden content, send, via a communication network, an interactive sticker display message to the receiver-side computing device based at least on the interactive sticker being displayed in the messaging GUI, wherein the receiver-side computing device is configured to display the interactive sticker in a corresponding messaging GUI displayed via a receiver-side display of the receiver-side computing device based at least on receiving the interactive sticker display message, receive, via the communication network, an interactive sticker interaction message from the receiver-side computing device, wherein the receiver-side computing device is configured to send the interactive sticker interaction message to the sender-side computing device based at least on the interactive sticker that is displayed in the corresponding messaging GUI being interacted with via user input to the receiver-side computing device, and display, via the display, the hidden content associated with the interactive sticker in the messaging GUI based at least on receiving the interactive sticker interaction message from the receiver-side computing device, wherein the receiver-side computing device is configured to display the hidden content associated with the interactive sticker in the corresponding messaging GUI based at least on the interactive sticker being interacted with via the user input to the receiver-side computing device. In this example and/or other examples, the sender-side computing device may comprise an input subsystem, and the one or more processors may be configured to execute instructions stored in memory to display, via the display, an interactive sticker button in the messaging GUI, and receive, via the input subsystem, user input indicating selection of the interactive sticker button, the interactive sticker may be displayed in the messaging GUI based at least on the interactive sticker button being selected via the user input. In this example and/or other examples, the one or more processors may be configured to execute instructions stored in memory to display, via the display, an educational overlay that emphasizes the interactive sticker button in the messaging GUI, the educational overlay may include instructions for using the interactive sticker button to display the interactive sticker. In this example and/or other examples, the one or more processors may be configured to execute instructions stored in memory to, based at least on receiving, via the input subsystem, user input corresponding to a selection in a location of the messaging GUI that is outside the educational overlay, remove the educational overlay from being displayed in the messaging GUI. In this example and/or other examples, the hidden content may replace the interactive sticker in the messaging GUI when the hidden content is displayed in the messaging GUI. In this example and/or other examples, the messaging GUI may include a sequence of in-line messages sent between the first user and the second user, the interactive sticker may be displayed in the sequence of in-line messages in the messaging GUI, and the hidden content may be displayed in the sequence of in-line messages in the messaging GUI. In this example and/or other examples, the hidden content may comprise a piece of pre-determined content selected from a library of pre-determined content. In this example and/or other examples, the hidden content may comprise artificial intelligence (AI)-generated content that is generated based at least on a user prompt. In this example and/or other examples, the hidden content may comprise third-party content generated by a third user that is linked to the first user and the second user in the social media application.

In another example, a receiver-side computing device for social media application interaction comprises one or more processors configured to execute instructions stored in memory to execute a social media application configured to generate a messaging graphical user interface (GUI) via a display, wherein the messaging GUI facilitates communication between a first user associated with a sender-side computing device and a second user associated with the receiver-side computing device, receive, via a communication network, an interactive sticker display message from the sender-side computing device, display, via the display, an interactive sticker in the messaging GUI based at least on receiving the interactive sticker display message, wherein the interactive sticker is associated with hidden content, receive, via an input subsystem, user input that interacts with the interactive sticker in the messaging GUI, send, via the communication network, an interactive sticker interaction message to the sender-side computing device based at least on receiving the user input that interacts with the interactive sticker in the messaging GUI, and display, via the display, the hidden content associated with the interactive sticker in the messaging GUI based at least on receiving the user input that interacts with the interactive sticker in the messaging GUI, wherein the sender-side computing device is configured to display the hidden content associated with the interactive sticker in the corresponding messaging GUI based at least on receiving the interactive sticker interaction message. In this example and/or other examples, the one or more processors may be configured to execute instructions stored in memory to display, via the display, an educational message that emphasizes the interactive sticker in the messaging GUI, the educational message may include instructions for interacting with the interactive sticker to display the hidden content in the messaging GUI. In this example and/or other examples, the one or more processors may be configured to execute instructions stored in memory to adjust, via the display, a visual appearance of the interactive sticker in the messaging GUI based at least on a duration for which the interactive sticker has been displayed in the messaging GUI becoming greater than a threshold duration. In this example and/or other examples, the one or more processors may be configured to execute instructions stored in memory to remove the interactive sticker from being displayed in the messaging GUI based at least on a duration for which the interactive sticker has been displayed in the messaging GUI becoming greater than a threshold duration. In this example and/or other examples, the hidden content may replace the interactive sticker in the messaging GUI when the hidden content is displayed in the messaging GUI. In this example and/or other examples, the messaging GUI may include a sequence of in-line messages sent between the first user and the second user, the interactive sticker may be displayed in the sequence of in-line messages in the messaging GUI, and the hidden content may be displayed in the sequence of in-line messages in the messaging GUI. In this example and/or other examples, the hidden content may comprise a piece of pre-determined content selected from a library of pre-determined content. In this example and/or other examples, the hidden content may comprise artificial intelligence (AI)-generated content that is generated based at least on a user prompt. In this example and/or other examples, the hidden content may comprise third-party content generated by a third user that is linked to the first user and the second user in the social media application. In this example and/or other examples, the social media application may be configured to generate a content collection GUI including a collection of previously reveled content associated with a plurality of interactive stickers that the second user previously received and interacted with, and the one or more processors may be configured to execute instructions stored in memory to receive, via the input subsystem, user input indicating user selection of the content collection GUI, and display, via the display, the content collection GUI including the collection of previously revealed content based at least on receiving the user input indicating user selection of the content collection GUI.

In yet another example, a method for communication comprises executing a social media application configured to generate a messaging graphical user interface (GUI) via a display of a sender-side computing device, wherein the messaging GUI facilitates communication between a first user associated with the sender-side computing device and a second user associated with a receiver-side computing device, displaying, via the display, an interactive sticker in the messaging GUI, wherein the interactive sticker is associated with hidden content, sending, via a communication network, an interactive sticker display message to the receiver-side computing device based at least on the interactive sticker being displayed in the messaging GUI, wherein the receiver-side computing device is configured to display the interactive sticker in a corresponding messaging GUI displayed via a receiver-side display of the receiver-side computing device based at least on receiving the interactive sticker display message, receiving, via the communication network, an interactive sticker interaction message from the receiver-side computing device, wherein the receiver-side computing device is configured to send the interactive sticker interaction message to the sender-side computing device based at least on the interactive sticker that is displayed in the corresponding messaging GUI being interacted with via user input to the receiver-side computing device, and displaying, via the display, the hidden content associated with the interactive sticker in the messaging GUI based at least on receiving the interactive sticker interaction message from the receiver-side computing device, wherein the receiver-side computing device is configured to display the hidden content associated with the interactive sticker in the corresponding messaging GUI based at least on the interactive sticker being interacted with via the user input to the receiver-side computing device.

In yet another example, a method for communication comprises executing a social media application configured to generate a messaging graphical user interface (GUI) via a display of a receiver-side computing device, wherein the messaging GUI facilitates communication between a first user associated with a sender-side computing device and a second user associated with the receiver-side computing device, receiving, via a communication network, an interactive sticker display message from the sender-side computing device, displaying, via the display, an interactive sticker in the messaging GUI based at least on receiving the interactive sticker display message, wherein the interactive sticker is associated with hidden content, receiving, via an input subsystem of the receiver-side computing device, user input that interacts with the interactive sticker in the messaging GUI, sending, via the communication network, an interactive sticker interaction message to the sender-side computing device based at least on receiving the user input that interacts with the interactive sticker in the messaging GUI, and displaying, via the display, the hidden content associated with the interactive sticker in the messaging GUI based at least on receiving the user input that interacts with the interactive sticker in the messaging GUI, wherein the sender-side computing device is configured to display the hidden content associated with the interactive sticker in the corresponding messaging GUI based at least on receiving the interactive sticker interaction message.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A sender-side computing device for social media application interactions, comprising:
one or more processors configured to execute instructions stored in memory to:
execute a social media application configured to generate a messaging graphical user interface (GUI) via the display, wherein the messaging GUI facilitates communication between a first user associated with the sender-side computing device and a second user associated with a receiver-side computing device;
display, via the display, an interactive sticker in the messaging GUI, wherein the interactive sticker is associated with hidden content;
send, via a communication network, an interactive sticker display message to the receiver-side computing device based at least on the interactive sticker being displayed in the messaging GUI, wherein the receiver-side computing device is configured to display the interactive sticker in a corresponding messaging GUI displayed via a receiver-side display of the receiver-side computing device based at least on receiving the interactive sticker display message;
receive, via the communication network, an interactive sticker interaction message from the receiver-side computing device, wherein the receiver-side computing device is configured to send the interactive sticker interaction message to the sender-side computing device based at least on the interactive sticker that is displayed in the corresponding messaging GUI being interacted with via user input to the receiver-side computing device; and
display, via the display, the hidden content associated with the interactive sticker in the messaging GUI based at least on receiving the interactive sticker interaction message from the receiver-side computing device, wherein the receiver-side computing device is configured to display the hidden content associated with the interactive sticker in the corresponding messaging GUI based at least on the interactive sticker being interacted with via the user input to the receiver-side computing device.

2. The sender-side computing device of claim 1, wherein the sender-side computing device comprises an input subsystem, and wherein the one or more processors are configured to execute instructions stored in memory to:
display, via the display, an interactive sticker button in the messaging GUI; and
receive, via the input subsystem, user input indicating selection of the interactive sticker button;
wherein the interactive sticker is displayed in the messaging GUI based at least on the interactive sticker button being selected via the user input.

3. The sender-side computing device of claim 2, wherein the one or more processors are configured to execute instructions stored in memory to:
display, via the display, an educational overlay that emphasizes the interactive sticker button in the messaging GUI, wherein the educational overlay includes instructions for using the interactive sticker button to display the interactive sticker.

4. The sender-side computing device of claim 3, wherein the one or more processors are configured to execute instructions stored in memory to:
based at least on receiving, via the input subsystem, user input corresponding to a selection in a location of the messaging GUI that is outside the educational overlay, remove the educational overlay from being displayed in the messaging GUI.

5. The sender-side computing device of claim 1, wherein the hidden content replaces the interactive sticker in the messaging GUI when the hidden content is displayed in the messaging GUI.

6. The sender-side computing device of claim 1, wherein the messaging GUI includes a sequence of in-line messages sent between the first user and the second user, wherein the interactive sticker is displayed in the sequence of in-line messages in the messaging GUI, and wherein the hidden content is displayed in the sequence of in-line messages in the messaging GUI.

7. The sender-side computing device of claim 1, wherein the hidden content comprises a piece of pre-determined content selected from a library of pre-determined content.

8. The sender-side computing device of claim 1, wherein the hidden content comprises artificial intelligence (AI)-generated content that is generated based at least on a user prompt.

9. The sender-side computing device of claim 1, wherein the hidden content comprises third-party content generated by a third user that is linked to the first user and the second user in the social media application.

10. A receiver-side computing device for social media application interactions, comprising:
one or more processors configured to execute instructions stored in memory to:
execute a social media application configured to generate a messaging graphical user interface (GUI) via a display, wherein the messaging GUI facilitates communication between a first user associated with a sender-side computing device and a second user associated with the receiver-side computing device;
receive, via a communication network, an interactive sticker display message from the sender-side computing device;
display, via the display, an interactive sticker in the messaging GUI based at least on receiving the interactive sticker display message, wherein the interactive sticker is associated with hidden content;
receive, via an input subsystem, user input that interacts with the interactive sticker in the messaging GUI;
send, via the communication network, an interactive sticker interaction message to the sender-side computing device based at least on receiving the user input that interacts with the interactive sticker in the messaging GUI; and
display, via the display, the hidden content associated with the interactive sticker in the messaging GUI based at least on receiving the user input that interacts with the interactive sticker in the messaging GUI, wherein the sender-side computing device is configured to display the hidden content associated with the interactive sticker in the corresponding messaging GUI based at least on receiving the interactive sticker interaction message.

11. The receiver-side computing device of claim 10, wherein the one or more processors are configured to execute instructions stored in memory to:
display, via the display, an educational message that emphasizes the interactive sticker in the messaging GUI, wherein the educational message includes instructions for interacting with the interactive sticker to display the hidden content in the messaging GUI.

12. The receiver-side computing device of claim 10, wherein the one or more processors are configured to execute instructions stored in memory to:
adjust, via the display, a visual appearance of the interactive sticker in the messaging GUI based at least on a duration for which the interactive sticker has been displayed in the messaging GUI becoming greater than a threshold duration.

13. The receiver-side computing device of claim 10, wherein the one or more processors are configured to execute instructions stored in memory to:
remove the interactive sticker from being displayed in the messaging GUI based at least on a duration for which the interactive sticker has been displayed in the messaging GUI becoming greater than a threshold duration.

14. The receiver-side computing device of claim 10, wherein the hidden content replaces the interactive sticker in the messaging GUI when the hidden content is displayed in the messaging GUI.

15. The receiver-side computing device of claim 10, wherein the messaging GUI includes a sequence of in-line messages sent between the first user and the second user, wherein the interactive sticker is displayed in the sequence of in-line messages in the messaging GUI, and wherein the hidden content is displayed in the sequence of in-line messages in the messaging GUI.

16. The receiver-side computing device of claim 10, wherein the hidden content comprises a piece of pre-determined content selected from a library of pre-determined content.

17. The receiver-side computing device of claim 10, wherein the hidden content comprises artificial intelligence (AI)-generated content that is generated based at least on a user prompt.

18. The receiver-side computing device of claim 10, wherein the hidden content comprises third-party content generated by a third user that is linked to the first user and the second user in the social media application.

19. The receiver-side computing device of claim 10, wherein the social media application is configured to generate a content collection GUI including a collection of previously reveled content associated with a plurality of interactive stickers that the second user previously received and interacted with, and wherein the one or more processors are configured to execute instructions stored in memory to:
receive, via the input subsystem, user input indicating user selection of the content collection GUI; and
display, via the display, the content collection GUI including the collection of previously revealed content based at least on receiving the user input indicating user selection of the content collection GUI.

20. A method for communication, the method comprising:
executing a social media application configured to generate a messaging graphical user interface (GUI) via a display of a sender-side computing device, wherein the messaging GUI facilitates communication between a first user associated with the sender-side computing device and a second user associated with a receiver-side computing device;
displaying, via the display, an interactive sticker in the messaging GUI, wherein the interactive sticker is associated with hidden content;
sending, via a communication network, an interactive sticker display message to the receiver-side computing device based at least on the interactive sticker being displayed in the messaging GUI, wherein the receiver-side computing device is configured to display the interactive sticker in a corresponding messaging GUI displayed via a receiver-side display of the receiver-side computing device based at least on receiving the interactive sticker display message;
receiving, via the communication network, an interactive sticker interaction message from the receiver-side computing device, wherein the receiver-side computing device is configured to send the interactive sticker interaction message to the sender-side computing device based at least on the interactive sticker that is displayed in the corresponding messaging GUI being interacted with via user input to the receiver-side computing device; and
displaying, via the display, the hidden content associated with the interactive sticker in the messaging GUI based at least on receiving the interactive sticker interaction message from the receiver-side computing device, wherein the receiver-side computing device is configured to display the hidden content associated with the interactive sticker in the corresponding messaging GUI based at least on the interactive sticker being interacted with via the user input to the receiver-side computing device.

21. A method for communication, the method comprising:
executing a social media application configured to generate a messaging graphical user interface (GUI) via a display of a receiver-side computing device, wherein the messaging GUI facilitates communication between a first user associated with a sender-side computing device and a second user associated with the receiver-side computing device;
receiving, via a communication network, an interactive sticker display message from the sender-side computing device;
displaying, via the display, an interactive sticker in the messaging GUI based at least on receiving the interactive sticker display message, wherein the interactive sticker is associated with hidden content;
receiving, via an input subsystem of the receiver-side computing device, user input that interacts with the interactive sticker in the messaging GUI;
sending, via the communication network, an interactive sticker interaction message to the sender-side computing device based at least on receiving the user input that interacts with the interactive sticker in the messaging GUI; and
displaying, via the display, the hidden content associated with the interactive sticker in the messaging GUI based at least on receiving the user input that interacts with the interactive sticker in the messaging GUI, wherein the sender-side computing device is configured to display the hidden content associated with the interactive sticker in the corresponding messaging GUI based at least on receiving the interactive sticker interaction message.
